(19) United States
(12) Patent Application Publication
(10) Pub. No.: US 2014/0195295 A1
(43) Pub. Date: Jul. 10, 2014

(54) TASK MANAGEMENT SYSTEM AND METHOD

(71) Applicant: SCHLUMBERGER TECHNOLOGY CORPORATION, Sugar Land, TX (US)

(72) Inventors: Stephen Whitley, Katy, TX (US); Floyd Louis Broussard, III, The Woodlands, TX (US); Brandon David Plost, Houston, TX (US); Scott Raphael, Houston, TX (US); Patrick Daniel Dineen, Katy, TX (US); Horacio Ricardo Bouzas, Oslo (NO); Cyril Laroche-Py, Houston, TX (US); Chad Brockman, Cypress, TX (US); Vignesh Venkataraman, Houston, TX (US)

(73) Assignee: SCHLUMBERGER TECHNOLOGY CORPORATION, Sugar Land, TX (US)

(21) Appl. No.: 14/146,552

(22) Filed: Jan. 2, 2014

Related U.S. Application Data
(60) Provisional application No. 61/751,155, filed on Jan. 10, 2013.
(60) Provisional application No. 61/751,160, filed on Jan. 10, 2013.

(51) Int. Cl. G06Q 10/06

(52) U.S. Cl. CPC G06Q 10/0633
USPC 705/7.27

(57) ABSTRACT

The invention provides a system, method, and computer readable medium for facilitating the execution of one or more tasks. Each worker may be provided with an electronic device capable of determining and transmitting its geographical location (and thus the worker's geographical location) to the computer system via one or more computer networks. In one embodiment, the system allows for the tracking of each task or work-related activity performed by each worker. The system may include pre-determined workflows to assist the worker in completing a task. Workflows may include recommended solutions to problems that may be encountered given the project or task at issue. In one embodiment, one or more effectiveness metrics may be utilized in order to ascertain the effectiveness of one or more of the workflows.

### CROSS REFERENCE TO RELATED APPLICATIONS

This patent application claims priority upon and incorporates by reference herein, a first provisional patent application entitled “Enabling Remote Execution through Location Based Software,” filed on Jan. 10, 2013, Ser. No. 61/751,155; and a second provisional patent application entitled “Operations Execution and Performance Tracking,” filed on Jan. 10, 2013, Ser. No. 61/751,160.

### BACKGROUND

Task management is an important component of any business activity. Specifically, the manner in which workers are assigned to one or more tasks may have a significant impact on the efficiency of an organization. Task management may be especially challenging for organizations having a large number of workers and a large number of geographically distinct job-sites where tasks are to be performed.

As such, there remains a need for a task management system and method capable of tracking and determining the effectiveness of worker activities in connection with one or more tasks.

### SUMMARY

Accordingly, in one embodiment, a system and method is described herein capable of tracking and determining the effectiveness of worker activities in connection with one or more tasks.

Task data pertaining to a plurality of tasks and worker data pertaining to one or more workers may be saved to a computer system. Each worker may be provided with an electronic device capable of determining and transmitting its geographical location (and thus the worker's geographical location) to the computer system via one or more computer networks.

In one embodiment, task data may include information such as the geographical location where the task is to be performed, the requisite skills necessary to complete the task, the importance/priority of the task relative to other tasks, a listing of the parts and/or tools required to execute the task, transportation requirements for the task, and/or the amount of time that the task has been pending but not completed.

In one embodiment, worker data may include information such as the geographical location of the worker, the worker's skill, training, and/or experience, the status of the worker, i.e., whether the worker is on-duty, off-duty, working after hours, on vacation, etc., a listing of parts and/or tools available to the worker and/or in their possession, and/or the transportation available to the worker.

In one embodiment, task data and worker data may be analyzed and compared in order to identify eligible workers for each task. This may involve the identification of a single “most eligible” worker for each task, or may involve identifying a group of workers that a supervisor or other personnel may choose from to assign to a particular task. Once eligible workers have been identified, they may be assigned to one or more tasks and notified accordingly.

In one embodiment, the system allows for the racking of each task or work-related activity performed by each worker. Tracking information may include information relating to actions taken by a worker in relation to one or more tasks, e.g., what action(s) were taken in order to solve a particular problem. This may be accomplished by cross-referencing stored device ID's with user ID's, along with stored information concerning the task at issue such as equipment type, services needed, etc.

The system may include predetermined workflows to assist the worker in completing a task. Workflows may be static or dynamic in nature. Workflows may include recommended solutions to problems that may be encountered given the project/task at issue.

The workflow information provided by the system may dynamically change based on the particular location (automatically detected) or be set by the task-giver (manually entered). The instructions may be dynamically updated such that if a worker skips a step as detected by the system, or if the situation at an incident/task location changes, the instructions for the worker may be updated.

In one embodiment, the location of the worker's mobile device may be calculated by the system and a list of nearby equipment for the task/project may be displayed, along with the user's calculated position. The user may then use a graphic user interface to pick the equipment they are about to service (or this may already be chosen within the request for a service to be performed) from the displayed list. In one embodiment, the system may be directed to access outside information sources, such as the internet or other databases accessible to the organization, in order to provide the best solution(s) to the worker.

In one embodiment, one or more effectiveness metrics may be utilized in order to ascertain the effectiveness of one or more workflows. In one embodiment, data pertaining to each workflow (and each sub-step of the sub-workflow where appropriate) may be analyzed in order to ascertain how effective the workflow was in solving the problem at hand.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings; it being understood that the drawings contained herein are not necessarily drawn to scale and that the accompanying drawings provide illustrative implementations and are not meant to limit the scope of various technologies described herein; wherein:

FIG. 1 is a flow chart diagram illustrating a task management process that may be used in connection with one embodiment.

FIG. 2 is a flow chart diagram illustrating an eligibility process that may be used in connection with one embodiment.

FIG. 3 is an example graphic user interface that may be used in connection with one embodiment.

FIG. 4 is a flow chart diagram illustrating a performance tracking process that may be used in connection with one embodiment.

### DESCRIPTION

In the following description, numerous details are set forth to provide an understanding of various embodiments of the invention. However, it will be understood by those skilled in the art that the invention may be practiced without these details and that numerous variations or modifications from the described embodiments may be possible.

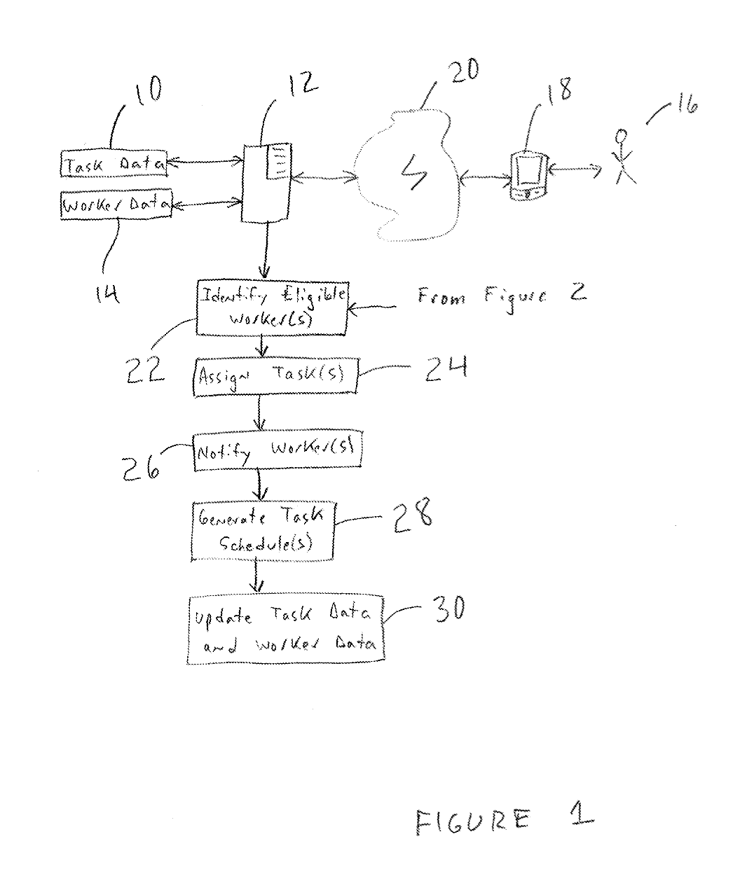

The present disclosure describes embodiments of a method of task management, a computer readable medium for task management and a task management system. Referring to FIG. 1, task data (10) pertaining to a plurality of tasks may be stored to a computer system (12) having one or more processor(s), database(s) and/or software Application(s). The computer system may be a server, stand-alone computer system or other suitable processing device.

Worker data (14) may be stored to the computer system (12). As used herein, a worker (16) may be any individual who may be assigned with a task. Workers may be employed by an organization, contract workers, temporary workers, part time workers, etc. In one embodiment, each worker (16) may be provided with an electronic device (18) capable of determining and transmitting its geographical location (and thus the worker's geographical location) to the computer system (12) via one or more computer networks (20).

In one embodiment, the electronic device may be a laptop, smart phone, tablet or other suitable device. The electronic device may track its location worldwide using triangulation between 3G/4G towers, using GPS or other suitable methodology. The electronic device may also be equipped with one or more software application(s) capable of capturing a location identification as well as a user ID of the worker associated therewith. Such application(s) may be further capable of displaying data necessary to complete any number of tasks, as described in more detail below.

As used herein, a task may be any unit of work to be done or undertaken by one or more workers. In one embodiment, task data may include information such as the geographical location where the task is to be performed, the requisite skills necessary to complete the task, the importance/priority of the task relative to other tasks, a listing of the parts and/or tools required to execute the task, transportation requirements for the task, and/or the amount of time that the task has been pending but not completed.

In one embodiment, worker data may include information such as the geographical location of the worker, the worker's skill, training, and/or experience, the status of the worker, i.e., whether the worker is on-duty, off-duty, working after hours, on vacation, etc., a listing of parts and/or tools available to the worker and/or in their possession, and/or the transportation available to the worker.

In one embodiment, task data and worker data may be analyzed and compared in order to identify eligible workers for each task, as illustrated by Box (22) of FIG. 1. This may involve the identification of a single “most eligible” worker for each task, or may involve identifying a group of worker(s) that a supervisor or other personnel may choose to assign to a particular task. Once eligible workers have been identified, they may be assigned to one or more tasks, as illustrated by Box (24).

Once a worker has been assigned to a task, he or she may be notified of the assignment as illustrated by Box (26). The worker may be notified in any suitable manner such as via email, text message, telephone message, facsimile transmission, etc. In one embodiment, a custom application may be used to generate a task schedule displayed upon the worker's electronic device, as illustrated by Box (28).

The task schedule may be automatically and/or manually updated to indicate that the worker has been assigned to a task. Further, the assigned worker may be provided with directions to the jobsite where the task is to be performed as well as instructions regarding how the assigned task is to be accomplished, as described further below. In one embodiment, the task data and worker data stored by the computer system may be updated to reflect the worker assignment, as illustrated by Box (30) of FIG. 1. In addition, the worker may also provide positive feedback to the system on acceptance of the task into their schedule.

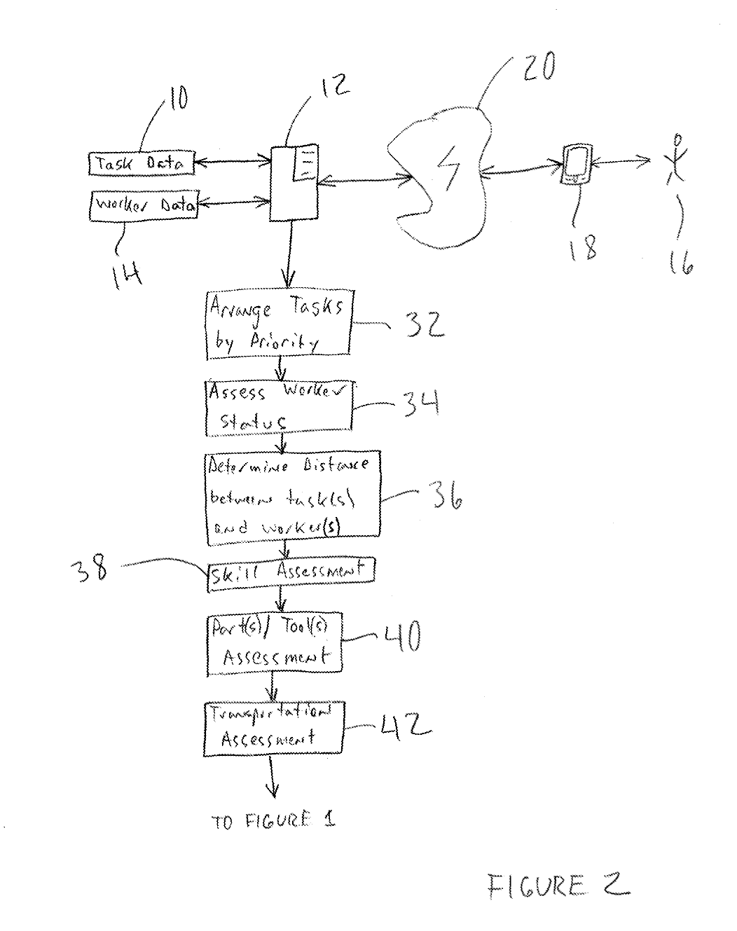

In one embodiment, tasks may be arranged according to priority for any given time period, as illustrated by Box (32) of FIG. 2. It may be difficult to manage a large numbers of workers to perform different tasks, be it reading meters or fixing problems. In some cases, workers travel by vehicle to each location, and have their schedule set at the beginning of each work shift. Thus, a priority queue may be utilized to dynamically route workers to where they are needed most, allowing tasks to be dynamically updated and/or amended throughout the day, all while minimizing non-productive time spent driving. Further, the system may track workers and their status to provide alerts on the status of tasks and their expected completion dates/times. Management of these alerts may allow a task assigner to redeploy additional workers or realign the schedule as needed.

Any number of factors may be utilized in order to determine a task's relative priority. For example, dangerous situations (gas leaks, etc) may be given a higher priority than tasks where no dangerous situation is present. In one embodiment, a supervisor or other personnel may indicate the relative priority of one or more tasks via a graphic user interface coupled to the computer system (12).

In one embodiment, the relative status of the worker may be assessed by the system in connection with determining a worker's eligibility to handle one or more tasks, as illustrated by Box (34). For example, workers who are listed as being on vacation, already working on another high priority project or otherwise unavailable may be automatically or manually removed from the eligibility determination.

In one embodiment, the location of the task and the location of the worker may be ascertained and compared in order to determine the distance between the task's location and the worker's location, as illustrated by Box (36) of FIG. 2. The distance between the task; and the worker may be computed as an “as the crow flies” value or in terms of the actual driving distance computed by the system. In one embodiment, traffic and/or road conditions may be taken into account in order to ascertain the real world travel time it will take for a worker to reach the task's location. The distance and/or the estimated travel time may be utilized in order to determine a worker's eligibility for the task in question. A GPS service such as Google Maps® may be utilized.

In one embodiment, the task worker may also interact with the system to acknowledge receipt of the assigned task, completion of the assigned task or notification of an extension to the assigned task. The worker may assign additional task(s) to the same location based on their assessment of the task(s) they have completed. These additional task(s) may be added to the system for assessment and assignment to appropriate workers. In one embodiment, task(s) that are not acknowledged or accepted by the assigned worker may be reassigned to alternate personnel.

In one embodiment, the system may analyze a list of stored tasks that need to be completed and cross-reference the locations for each of those tasks. For example, a list of tasks may include inspection of a pipeline and related hardware. Once the locations are identified the system may analyze a transportation route for a worker to take to perform the task, identify the most efficient path for a particular worker given their present location, and/or identify the path for a worker who has a specific skill set to complete specific tasks.

Each worker's location may be tracked by corresponding electronic device IDs to worker IDs. The location of the worker's electronic device may be calculated when necessary or on a real-time basis. For example, locations of workers may be updated at predefined time periods (one minute for example), and/or each electronic device may be “pinged” at the occurrence of an event, such as in advance of calculating which worker to select for one or more tasks.

In one embodiment, a skill assessment may be utilized during the worker eligibility determination process, as illustrated by Box (38). Workers may have varying background, skills and/or training. Therefore, the system may utilize a comparison of the requisite skill for a task to the skill level of one or more available workers in order to determine if a worker is qualified to handle the task. This feature may provide better quality and faster task execution by matching workers with relevant skills to the closest task that they are qualified to address.

The system may maintain a catalog of relevant skills mapped to one or more workers. For example, a new worker with little training may only be qualified to check gauges, whereas an experienced worker may be qualified to handle major repairs, change system settings, etc. When a need to address a specific task is identified, the system may determine the location of the task, determine the location of workers with respect to that location, determine the skill sets of workers with respect to the incident, and find the closest worker with the highest corresponding skill set. The system may connect to other systems capable of capturing training information, and expertise of workers to keep this information current.

In one embodiment, a parts/tools assessment may be utilized during the worker eligibility determination process, as illustrated by Box (40). In this example, information concerning the requisite parts/tools, if any, required to complete a task may be included in the task data stored by the system. Further, worker data directed to the parts/tools available to or accessible by each worker may be maintained by the system.

For example, if a new valve is required to complete a task, the system may include task data indicating that the valve is required (which may be provided as a required parts listing for the task). The task data, may then be cross referenced with worker data indicating what parts are available to each worker (which may be provided as a listing of available parts) in order to determine worker eligibility. This feature may prevent an undesirable situation where a worker is rooted to a job site but lacks the required part and/or tools to complete the task. Further the system may provide assessments of additional tools and/or workers that may be required based on analysis of previous similar/same tasks that have required additional work to be completed, requiring additional tools or workers.

In one embodiment, a transportation assessment may be utilized during the worker eligibility determination process, as illustrated by Box (42). In this example, information concerning the transportation needs of a task may be included in the task data stored by the system. This may include information such as the type of vehicle that will be required to reach the task location due to terrain or weather requirements.

For example, if the task location is in a remote area accessible only by a four wheel drive vehicle, the task data may include a requirement that the eligible worker have a four wheel drive vehicle at his or her disposal. The worker data may include information concerning the transportation available to each worker so that workers who do not have access to the required vehicle(s) may be removed from the list of eligible workers.

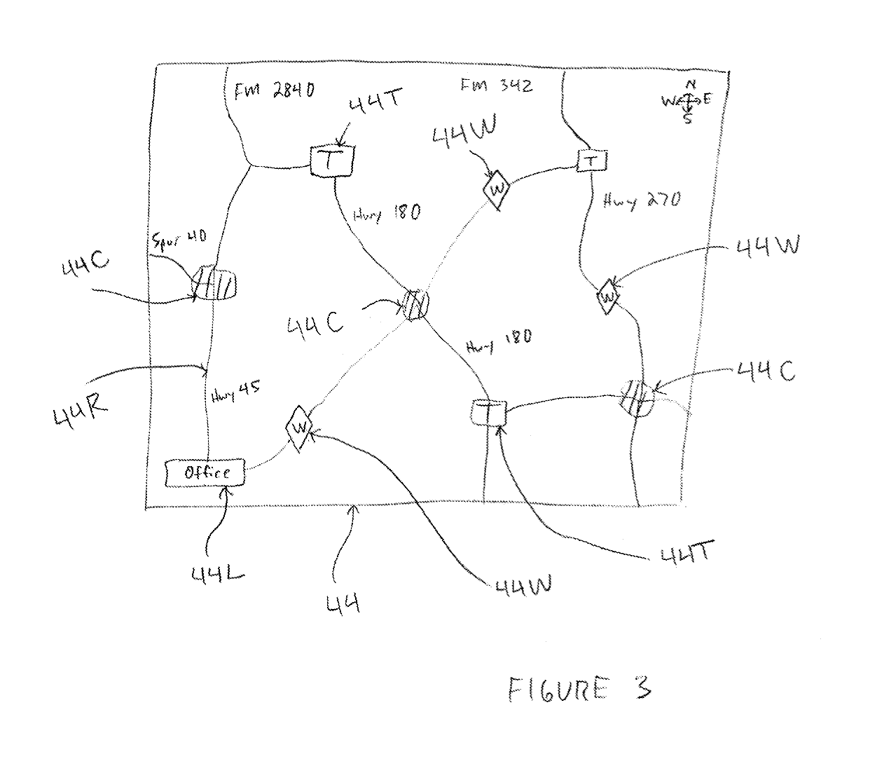

FIG. 3 illustrates an example graphic user interface that may be generated by the system. In this example, the graphic user interface (44) takes the form of a map of a geographical area illustrating multiple task locations (44T), multiple worker locations (44W), roads (44R), cities/settlements (44C), the location of the organization. (44L), etc. The graphic user interface may be displayed by the computer system and/or by one or more electronic devices.

In one embodiment, the graphic user interface may be generated during the worker eligibility/selection process in order to assist supervisory or other interested personnel in selecting eligible workers for one or more tasks. In one embodiment, the graphic user interface may provide other display functionality concerning an item of interest. For example, clicking on or hovering the mouse pointer over a worker's location (44W) may provide an additional display showing information such as the name of the worker, his or her skill level, his or her currently assigned task, the parts/tools in his or her possession, his or her available transportation, etc.

Further, the graphic user interface (44) may provide color coding and/or highlighting in order to emphasize one or more aspects of the task or worker data. For example, the system may color code a particular worker's designation on the map with a green/yellow/red color coding scheme to illustrate worker eligibility for a particular task. In this example, green may indicate an eligible worker, while a yellow or red color may indicate that the worker is not eligible or not available for whatever reason.

The above features may also include a prioritization component. For example, a high priority incident may override selecting a worker based on skill set and, instead, select the closest worker to handle the incident, or at least the closest worker with an acceptable skill set to handle the task. The worker may then be sent instructions on how to address the incident as necessary.

The above eligibility features may be utilized alone or according to various combinations. Further, they may be utilized in order to create an “emergency” incident response arrangement. That is, a worker maybe dynamically routed to a particular task (or incident) during their normal work as needed. Dynamic routing may also be used in conjunction with problem identification by supervisory personnel to each potential problem area (in a pipeline perhaps) and having them inspect each location for issues.

Aside from the day to day tasks in the field (reading meters, tank levels, etc.), there is further potential for better use of field personnel for other tasks. For example, if a production engineer is watching a well and realizes that a valve needs to be adjusted, the closest worker to that well may be able to perform the actual adjustment if the task is entered into a system by the production engineer. In this example, the field personnel is not making the decision on whether the valve needs to be turned, but is executing the operation in a timely manner since the task will be dynamically added to their route.

In one embodiment, tasks may be scheduled so as to minimize travel time from one task location to another. This may be accomplished by generating a schedule of tasks for the worker where each task location is positioned within a certain geographical area (or radius from the worker's location). The system may also assign individual tasks to a worker and then restrict subsequent task assignments to those task(s) located within a certain geographical distance of the worker's location.

In one embodiment, the system may provide route tracking, route preservation and route editing features through which an organization may view routes for each worker via a Geographical Information System (GIS) or other suitable functionality. Further, the system may utilize voice guidance GPS to inform workers of assigned task(s) and/or make changes or enhancements to their schedule. Further, the system may generate a driving route for one or more workers using information from the worker's customary route and then generate a data capture description ordered by priority and/or geographical distance. This may also be accomplished via selection of equipment filtered by the worker using a search radius relative to his or her driving route. Updates and new routes may be enabled as well.

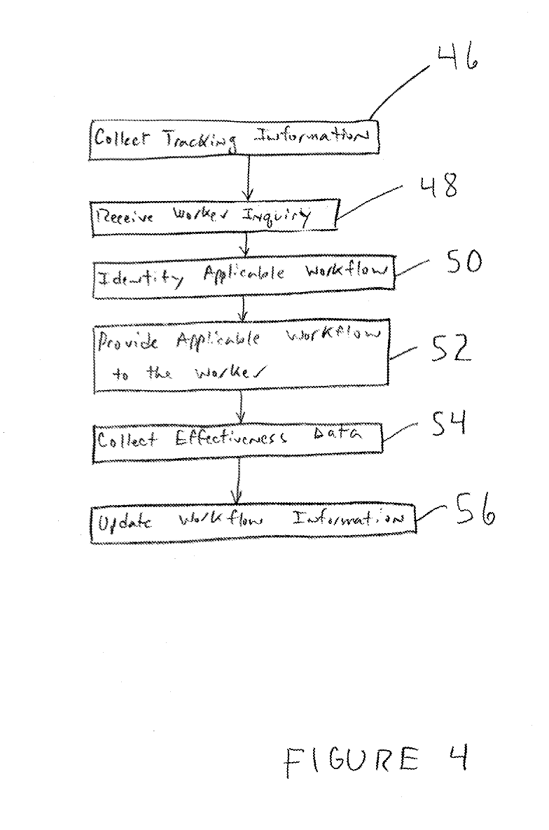

In one embodiment, the system allows for the tracking of each, task or work-related activity performed by each worker. Tracking information may be collected by the system and used for future reference, as illustrated by Box (46) of FIG. 4. Tracking information may include information relating to actions taken by a worker in relation to one or more tasks, e.g., what action(s) were taken in order to solve a particular problem. This may be accomplished by cross-referencing stored device ID's with user ID's, along with stored information concerning the task at issue such as equipment type, services needed, etc.

Tracking information may also be gleaned from information entered into the worker's mobile device in connection with one or more tasks. Worker tasks may be tied not only to the physical well, pump, valve, etc., that he or she is working on, but also to the problem that caused the need for such a fix (if it is a problem resolution), and/or the worker who initiated the activity.

The system may generate one or more workflows to assist the worker in completing a task. Workflows may be static or dynamic in nature. Workflows may include recommended solutions to problems that may be encountered given the project/task at issue. Workflows may be manually entered into the system and/or generated using stored tracking information. For example, experienced workers and/or otherwise qualified personnel may manually enter data into the system with or without an accompanying task in order to generate a workflow database. The workflow database may be made available to workers in connection with future tasks, thus improving worker efficiency.

In one example, a worker may access stored workflows relating to servicing a particular piece of equipment via an electronic request through his or her mobile device. For example, the worker arrives at the task location, identifies the piece of equipment to be serviced and then accesses stored workflow information relating thereto via an electronic request through his or her mobile device. The user request may be received by the system and the workflow database may be searched in order to locate/identify workflow data applicable to the worker's inquiry, as illustrated by Boxes (48 and 50) of FIG. 4.

Stored workflow information may include step by step instructions, questions, prompts, photos, video, audio and/or other suitable material in order to assist the worker in accomplishing a given task. Once identified by the system, applicable workflow data may be provided to the worker via transmission to his or her mobile device, as illustrated by Box (52) of FIG. 4. The workflow information provided by the system may dynamically change based on the particular location (automatically detected) or be set by the task-giver (manually entered). The instructions may be dynamically updated such that if a worker skips a step as detected by the system, or if the situation at an incident/task location changes, the instructions for the worker may be updated.

In one embodiment, the system may dynamically amend and/or update task information, worker information, workflow information, etc., in response to real-world conditions. For example, if a worker encounters a task that is not viable for whatever reason, i.e., due to incorrect task description, incorrect worker competency, incorrect equipment, incorrect tools, workflow incomplete or inapplicable, worker unable to reach task location, etc., the system may provide updated/corrected task information to the worker via his or her mobile device. Further, the incorrect task (in this example) may be deleted/closed and a new corrected task may be entered into the system. In one embodiment, the system may provide a graphic user interface through which the worker may identify non-viable tasks and indicate why the task is not viable and/or how it may be corrected.

In one embodiment, the amount of workflow information provided to the worker in connection with a task may be adjusted based upon the worker's experience level, familiarity with the equipment at issue, worker preferences, etc. In one embodiment, each worker may be assigned a rating for each type of equipment at issue such that the workflows may be adjusted depending on the type of equipment at issue and the worker's rating with the identified equipment. Example worker equipment ratings may include designations such a basic, intermediate, advanced, expert, etc. In this example, a worker with a rating of basic may be provided with more workflow guidance (in the form, of instructions, questions prompts, etc) by the system than a worker with an expert rating.

In one embodiment, information concerning a particular task may be transmitted from, the worker's mobile device to a supervisor so that the supervisor may review the situation and assist, the worker with the task. For example, the supervisor may be presented with a list of possible solution(s) for his or her worker, so that, the supervisor may then select the optimal solution from the list of choices. The optimal solution may then be transmitted back to the worker so that he or she may apply the solution to the task at hand.

In one embodiment, applicable workflow information may be identified through a keyword search entered into the worker's mobile device. Search parameters such as the task location, equipment name/type, problem description, etc., may be utilized to identify workflow data applicable to the worker's current task. Further, workflow information may be identified through image recognition technologies. For example, the system may receive one or more images pertaining to a piece of equipment (such as a picture of the equipment taken by the worker at the task location) and use image recognition techniques in order to match one or more stored workflows to the equipment and or task in question.

Moreover, the system may identify applicable workflows by determining the current location of the worker (via GPS or triangulation for example) and matching the worker's location with the location of his or her currently scheduled task. The system may then retrieve workflows pertaining to equipment known to be present at the scheduled task location and display one or more applicable workflows to the worker.

In one embodiment, the location of the worker's mobile device may be calculated by the system and a list of nearby equipment for the task/project may be displayed, along with the user's calculated position. The worker may then use a graphic user interface to pick the equipment they are about to service (or this may already be chosen within the request for a service to be performed) from the displayed list. In one embodiment, the system may be directed to access outside information sources, such as the internet or other databases accessible to the organization, in order to provide the best solution(s) to the worker.

The workflow(s) may include display prompts at the end of recommended fixes/solutions (or displayed in conjunction with each recommended fix/solution step) to allow the worker to enter information regarding whether a particular fix for a problem worked and/or to confirm that the user has completed a task. In this example, the system may utilize worker inputs to track what services and/or actions have been, performed on a given piece of equipment as well as information regarding which solution(s) were most effective, as illustrated by Box (54) of FIG. 4. This information may be stored, analyzed and applied to future workflows. For example, workflows may be ranked according to their effectiveness and displayed to the user in order of effectiveness for future tasks/projects.

In one embodiment, one or more effectiveness metrics may be utilized in order to ascertain the effectiveness of one or more workflows. In one embodiment, tracking data pertaining to each workflow (or one or more sub-steps of the workflow(s) where appropriate) may be analyzed in order to ascertain how effective the workflow was in solving the problem at hand.

In one embodiment, the system may determine the mean time to next failure, i.e., how long the solution or fix provided by the workflow was effective for a given problem or piece of equipment. In one embodiment, the mean time to next failure may be calculated as the average time from the last fix to the next problem solution request. Effectiveness information may be used to update stored workflow information utilizing a feedback loop arrangement, so that the better (longer lasting in this example) fixes are suggested to the worker before less effective fixes, as illustrated by Box (56) of FIG. 4. The number of instances that a particular fix/solution has been utilized successfully may also be tracked and analyzed by the system. The system may rank possible workflows and/or workflow steps so that more effective ones are given priority for future task execution.

In one embodiment, effectiveness metrics may be utilized to evaluate worker performance. For example, workers who are responsible for more effective solutions may be given priority during scheduling of future projects/tasks. Further, worker effectiveness may be utilized by human resource departments as part of the worker evaluation process. For example, decisions regarding worker compensation, bonuses, etc., may be based upon real-world effectiveness data so that the workers who do the best work are rewarded accordingly.

In one embodiment, the system may provide a graphic user interface for displaying worker effectiveness and/or worker efficiency for one or more assigned task(s). In one embodiment, the amount of time spent by each worker on each task may be cross-referenced with effectiveness data so as to provide meaningful feedback regarding the worker's efficiency and effectiveness in combination.

The concepts described herein may be used in a number of industries, both inside and outside of oil and gas production. For example, any industry that has at least a portion of its business carried out by personnel transported by vehicles may benefit. One example may be the electricity industry (power companies).

The methods described herein may be implemented on any suitable computer system capable of processing electronic data. Computer system(s), may run programs containing instructions, that, when executed, perform methods according to the principles described herein. Furthermore, the methods described herein may be fully automated and able to operate continuously, as desired.

The computer system may utilize one or more central processing units, memory, communications or I/O modules, graphics devices, and mass storage devices such as tapes and discs. Storage device may include a floppy drive, hard drive, CD-ROM, optical drive, or any other form of storage device. In addition, the storage devices may be capable of receiving a floppy disk, CD-ROM, DVD-ROM, disk, flash drive or any other form of computer-readable medium that may contain computer-executable instructions. Further communication device may be a modem, network card, or any other device to enable communication to receive and/or transmit data. It should be understood that the computer system may include a plurality of interconnected (whether by intranet: or Internet) computer systems, including without limitation, personal computers, mainframes, PDAs, cell phones and the like.

It should be understood that the various technologies described herein may be implemented in connection with hardware, software or a combination of both. Thus, various technologies, or certain aspects or portions thereof may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies.

In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like.

Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

The computer system may include hardware capable of executing machine readable instructions, as well as the software for executing acts that produce a desired result. In addition, computer system may include hybrids of hardware and software, as well as computer sub-systems.

Hardware may include at least processor-capable platforms, such as client-machines (also known as personal computers or servers), and hand-held processing devices (such as smart phones, personal digital assistants (PDAs), or personal computing devices (PCDs), for example). Further, hardware may include any physical device that is capable of storing machine-readable instructions, such as memory or other data storage devices. Other forms of hardware include hardware sub-systems, including transfer devices such as modems, modem cards, ports, and port cards, for example.

Software includes any machine code stored in any memory medium, such as RAM or ROM, and machine code stored on other devices (such as floppy disks, flash memory, or a CD ROM, for example). Software may include source or object code, for example. In addition, software encompasses any set of instructions capable of being executed in a client machine or server.

A database may be any standard or proprietary database software, such as Oracle, Microsoft Access, SyBase, SQL or DBase II, for example. The database may have fields, records, data, and other database elements that may be associated through database specific software. Additionally, data may be mapped. Mapping is the process of associating one data entry with another data entry. For example, the data contained in the location of a character file can be mapped to a field in a second table. The physical location of the database is not limiting, and the database may be distributed. For example, the database may exist remotely from the server, and run on a separate platform.

Further, the computer system may operate in a networked environment using logical connections to one or more remote computers. The logical connections may be any connection that is commonplace in offices, enterprise-wide computer networks, intranets, and the Internet, such as local area network (LAN) and a wide area network (WAN). The remote computers may each include one or more application programs.

When using a LAN networking environment, the computer system may be connected to the local network through a network interface or adapter. When used in a WAN networking environment, the computer system may include a modem, wireless router or other means for establishing communication over a wide area network, such as the Internet. The modem, which may be internal or external, may be connected to the system bus via the serial port interface. In a networked environment, program modules depicted relative to the computer system, or portions thereof, may be stored in a remote memory storage device.

Although the invention has been described with reference to specific embodiments, this description is not meant to be construed in a limited sense. Various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention.

What is claimed is:

1. A computer implemented method of task management comprising:
storing task data pertaining to a plurality of tasks;
storing worker data pertaining to a plurality of workers;
storing workflow data pertaining to one or more of the tasks;
identifying workflow data applicable to a first task; and
providing the identified workflow data to a first worker assigned to complete the first task.

2. The computer implemented method of claim 1, further comprising:
receiving a worker inquiry requesting workflow data applicable to the first task;
providing the identified workflow data to the worker making the inquiry.

3. The computer implemented method of claim 1, wherein the task data further comprises a geographical location associated with each task and wherein the worker data further comprises a geographical location of each worker.

4. The computer implemented method of claim 1, wherein the workflow data pertaining to the first task is identified at least in part utilizing a geographical location associated with the first task and a geographical location associated with the first worker.

5. The computer implemented method of claim 1, wherein the identified workflow data further comprises at least one recommended solution for the first task.

6. The computer implemented method of claim 1, wherein each worker is equipped with an electronic device operative to determine their geographic location.

7. The computer implemented method of claim 1, wherein the identified workflow data further comprises instructions for completing the first task.

8. The computer implemented method of claim 1, further comprising:
storing tracking data pertaining to one or more tasks completed by one or more workers; and
updating the workflow data utilizing the tracking data.

9. The computer implemented method of claim 2, wherein the worker inquiry further comprises an identification of at least one piece of equipment associated with the first task.

10. The computer implemented method of claim 1, wherein the identified workflow data is adjusted based upon an experience rating applied to the first worker.

11. The computer implemented method of claim 1, further comprising:
applying one or more effectiveness metrics to the workflow data; and
ranking the workflow data according to effectiveness.

12. The computer implemented method of claim 11, wherein the effectiveness metric further comprises a mean time to next failure.

13. The computer implemented method of claim 11, wherein the effectiveness metric further comprises a number of successful uses.

14. The computer implemented method of claim 11, farther comprising:
evaluating worker performance utilizing one or more of the effectiveness metrics.

15. A computer system for task management comprising:
a processor operative to:
store task data pertaining to a plurality of tasks;
store worker data pertaining to a plurality of workers;
store workflow data pertaining to one or more of the tasks;
receive a worker inquiry requesting workflow data applicable to a first task;
identify workflow data applicable to a first task; and
provide the identified workflow data to the worker making the inquiry.

16. The computer system of claim 15, wherein the processor is operative to: generate a map illustrating at least a portion of the task data and at least a portion of the worker data.

17. The computer system of claim 16, wherein at least a portion of the task data or worker data illustrated on the map is color coded or highlighted.

18. A computer-readable storage medium for task management comprising instructions which, when executed, cause a computing device to:
store task data pertaining to a plurality of tasks;
store worker data pertaining to a plurality of workers;
store workflow data pertaining to one or more of the tasks;
identify workflow data applicable to a first task, wherein the identified workflow data further comprises instructions for completing the first task; and
provide the identified workflow data to a first worker assigned to complete the first task.

19. The computer-readable medium of claim 18, wherein the instructions, when executed, cause the computing device to apply one or more effectiveness metrics to the workflow data.

20. The computer-readable medium of claim 19, wherein the instructions, when executed, cause the computing device to evaluate worker performance utilizing one or more of the effectiveness metrics.
